(19) United States
(12) Patent Application Publication
(10) Pub. No.: US 2025/0223068 A1
(43) Pub. Date: Jul. 10, 2025

(54) FILLING PLANT HAVING A CENTRAL CONTROL DEVICE

(71) Applicant: Krones AG, Neutraubling (DE)

(72) Inventors: Jakob WEBER, Regensburg (DE); Thomas ZECH, Donaustauf (DE); Ingo SCHARF, Teublitz (DE)

(21) Appl. No.: 19/008,430

(22) Filed: Jan. 2, 2025

(30) Foreign Application Priority Data
Jan. 4, 2024 (DE) 10 2024 100 166.6

(51) Int. Cl. B65B 57/00

(52) U.S. Cl. CPC B65B 57/00

(57) ABSTRACT

The present disclosure relates to a filling plant having a plurality of machines, each of which is configured to perform operating functions on the basis of a respective set of commands, and a central control device that is configured to control the operating functions of the plurality of machines. Furthermore, the filling plant comprises a graphical user interface, which is configured to communicate with the central control device and to provide a user with graphically supported programming of the central control device.

### CROSS REFERENCE TO RELATED APPLICATION

The present application claims priority to German Patent Application No. 10 2024100 166.6 filed on Jan. 4, 2024. The entire contents of the above-listed application are hereby incorporated by reference for all purposes

### TECHNICAL FIELD OF THE DISCLOSURE

The present disclosure relates to the field of filling plants and in particular to the central control/regulation of the operation of the machines of the filling plants.

### BACKGROUND

Filling plants for beverages or the like comprise a plurality of production units connected in series, such as filling machines, labeling machines and packaging machines. These can be configured at least partially as rotary machines that are coupled to one another by means of rotating transfer apparatuses. Alternatively, the production units can also be configured as straight-line systems and/or connected to one another via linear transport devices, distribution devices and product buffers. The individual machines in a filling plant only communicate with their direct predecessor or successor machines (in the production line) by means of signal exchange and have no information about the operating status of the other machine contained in the line.

### SUMMARY

Individual functions of the individual machines must be selected manually by the operator or can only be selected by machines immediately upstream or downstream in the production line. Customer-specific inspection and monitoring functions must be newly created for each order in the respective machines for each customer. These functions cannot be reused for other machines and can only be created by subject matter experts with detailed programming knowledge. Furthermore, the functions must also be dynamically maintained/adapted and maintained, as a result of which the complexity and cost of implementing updated as well as new functions are increased.

The present disclosure is thus based on an object of providing a filling plant with an improved programmable control apparatus, which makes possible a simple and quickly implemented dynamic adaptation of the control of the operating sequences of the individual machines of the filling plant.

### DESCRIPTION OF THE DISCLOSURE

The above-mentioned object is achieved by a filling plant having a plurality of machines, each of which is configured to perform operating functions on the basis of a respective set of commands, and a central control device that is configured to control the operating functions of the plurality of machines. Furthermore, the filling plant comprises a graphical user interface, which is configured to communicate with the central control device and to provide a user with graphically supported programming of the central control device.

Here, the term control device is understood as a control and/or regulating device (open or closed loop control), and the term “control” also comprises controlling and/or regulating (open or closed loop control). The control device can comprise artificial intelligence. This artificial intelligence can be configured in the form of an artificial neural network. Thus, self-learning systems can be used to control/regulate the production and treatment processes carried out by the working machines of the plant.

In general, the set of commands of each machine can be stored in the respective machine (i.e., in a memory or storage medium) or in a storage medium external to the respective machine, for example the cloud.

According to the disclosure, the central control device in conjunction with the graphical user interface (GUI device) allows a relatively easy-to-operate superordinate control of all operating functions/line sequences of the machines in the plant. All information about all operating sequences can be taken into account at a control level that is superordinate to the individual operating functions/line sequences of the machines. Here, individual commands of the sets of commands, in particular individual commands of the set of commands of one of the plurality of machines having individual commands of the set of commands of another of the plurality of machines, can be suitably combined with one another for optimizing the process flow of the production/treatment line of the plant.

The central control device can also run so as to be distributed across a plurality of physical systems.

All information about the production line can be provided at a central location on/for the central control device. In particular, different line applications can be implemented flexibly and without customer-specific programming in the machines. Specific line applications can thus be configured in the customer project. Compared to the prior art, such a solution is less prone to errors and the commissioning time of a new production line can be reduced. Line operation via central control also allows for better, uniform documentation.

According to an embodiment, each of the machines comprises an individual machine controller, which is configured to control the operating functions of the respective machine on the basis of the respective set of commands, and the central control device is configured to control each of the individual machine controllers in order to control the operating functions of the plurality of machines. Here, in particular, the central control device can be configured to control the operating functions of the plurality of machines via the individual machine controllers, and the graphical user interface can be configured to provide the user with programmable access to the respective set of commands of the plurality of machines. The individual commands of the sets of commands can be displayed graphically on the graphical user interface, so that an intuitive link of individual commands in a process flow is made possible quickly and easily.

In particular, the graphical user interface of the filling plant can be configured to provide the user with low-code or no-code programming of the central control device. This makes intuitive programming possible without specific programming knowledge or knowledge of a particular programming language. Here, the graphical user interface can be configured to graphically provide the selection of individual commands and the creation of links between selected individual commands of the respective sets of commands of the plurality of machines and/or the central control device.

In addition, in the low-code or no-code environment, operating sequences can be configured in a customer-specific manner and do not have to be programmed by subject-matter experts with detailed programming knowledge, as was previously the case. As a result of the fact that operating sequences are configured in a comprehensive low-code or no-code environment, implemented solutions can be flexibly adapted to different configurations of the production line. The container and pack types processed in the production line are also independent of the functional links created in the low-code or no-code environment. Customer-side manufacturing execution systems (MES) can be connected to standard interfaces of existing machines using the flexible configuration options of low-code or no-code programming.

According to a further embodiment, the graphical user interface is configured to display information about the operating functions of the respective machine. Thus, the user can detect all relevant operating parameters via the same graphical user interface that is used to program the central control device and, advantageously, take them into account, for example, when programming or generally when operating the plant.

According to a further embodiment, the plant comprises a chatbot, which comprises the graphical user interface. The chatbot is a computer-implemented dialog system that can be used to communicate via text input or speech, so that it intelligently supports the operator in operating a machine in the filling plant and, in particular, in programming the central control device. The chatbot can comprise or be connected to a voice output. A dialog with an operator can be conducted via such a voice output. The chatbot can receive voice input recorded by a microphone or text input from an operator as input.

Furthermore, the chatbot can be configured to present diagnostic information about the operating sequences of the machines.

The chatbot can comprise a speaker recognition module, which is used in particular for speaker identification. It can also be used for speaker verification, i.e., checking the identity of a speaker specified by an operator. Using the speaker recognition module, the chatbot can recognize an operator and thus adapt the dialog with the recognized operator to that operator. For example, a dialog with an operator who is recognized as an experienced operator will differ in terms of complexity and detail from a dialog with another operator who is recognized as a less experienced operator. The dialog can thus be adapted to suit the training or experience of the operator. The dialog can also be adapted to the competence of the recognized operator, so that the operator can be prevented from attempting to initiate an operation for which they are not authorized.

In particular, the chatbot can be equipped with or connected to an artificial intelligence (AI) module, with the aid of which it can learn. Thus, for example, upon recognizing an operator, it can use the above-mentioned speaker recognition module to draw conclusions about the operator's level of experience or training from their dialog behavior, which develops over time, and adapt its own dialog behavior in line with the learning outcome. Thus, an operator profile can be dynamically managed, saved and used for learning. The operator profile can contain data about the qualifications and competencies of the operator, which determine the extent to which the operator is permitted to influence the operation of which machines and which components of the machines. The operator profile can also be used for speech recognition of an operator's voice input. The AI module can also be used for learning/training the above-mentioned speech recognition and speaker recognition. In particular, the AI module can intelligently support the operator when programming the central control device with the aid of the graphical interface device. The AI module can be geared towards machine learning and can be or comprise an artificial neural network.

The filling plant according to one of the examples described above can be a plant for producing and treating plastic bottles or glass bottles or aluminum cans or more generally containers made of plastic or glass or aluminum, or the filling plant according to one of the examples described above can be a plant for producing and treating containers made of at least one natural organic material (for example, paper) or comprising at least one natural organic material (for example, paper).

Thus, according to an embodiment, the plurality of machines comprises a production machine for forming containers from plastic, in particular a blow molding machine, or for forming containers from glass, or for forming containers from aluminum, a filling machine for filling the formed containers and a labeling machine for labeling the formed containers or the filled containers.

According to a further embodiment, the plurality of machines comprises a production machine for forming containers from at least one natural organic material or comprising at least one natural organic material, a filling machine for filling the formed containers and a decorating machine for decorating the formed or filled containers.

In the following, embodiments of a method according to the disclosure are described with reference to the drawing. The described embodiments are to be considered in all respects as illustrative and not restrictive, and various combinations of the listed features are included in the disclosure.

### BRIEF DESCRIPTION OF THE FIGURES

FIG. 1 shows schematically a plant for producing and treating plastic containers according to an example of the present disclosure.

FIG. 2 shows a GUI that can be used by way of example for programming the control of a plant for producing and treating containers.

FIG. 3 shows details of an exemplary filling plant.

FIG. 4 shows schematically a plant for producing and treating containers from at least one natural organic material or comprising at least one natural organic material, according to an example of the present disclosure.

### DETAILED DESCRIPTION

The present disclosure relates to a filling plant or plant for producing and treating containers with plurality of machines and in particular to the control or programming of the control of operating sequences of the machines. The programming of a central control device of the plant is carried out intuitively and easily via a graphical user interface (GUI) that provides low-code or no-code programming.

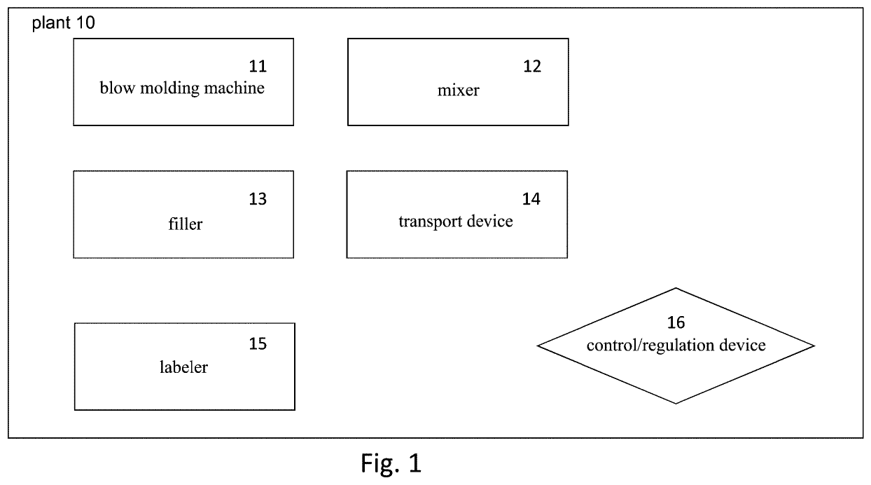

An exemplary plant 10 is shown schematically in FIG. 1. The plant 10 comprises a plurality of machines, each of which is configured to perform its operating functions on the basis of a respective set of instructions. The plurality of machines of the plant 10 comprise a blow molding machine 11 for producing plastic containers, a mixer 12 for producing the product to be filled, a filler 13 for filling the product into the plastic containers produced in the blow molding machine 11, a transport device 14 with a plurality of transport wheels and, if applicable, transport stars for transporting the containers between the individual machines and a labeler 15 for labeling the produced or filled containers.

Furthermore, the plant 10 comprises a central control/regulation device 16 (open or closed loop control), which is configured to control the operating functions of the individual machines. Each of the plurality of machines can have its own software, which is stored, for example, in a memory of the respective machine or in the cloud, and maps events/processes of the respective machine. The control by the central control/regulation device 16 is carried out via corresponding programming, which allows access to the software of the machines. With the aid of the correspondingly programmed central control/regulation device 16, commands from the machine software are suitably combined in order to control and optimize the operating sequence of the production line.

The control/regulation device 16 can comprise artificial intelligence. This artificial intelligence can be configured in the form of an artificial neural network. Thus, self-learning systems can be used to control/regulate the production and treatment processes carried out by the working machines of the plant.

The programming of the central control/regulation device 16 is carried out with the aid of a graphical user interface (GUI), which is configured to communicate with the central control device and to provide a user with graphically supported programming, in particular low-code or no-code programming, of the central control device.

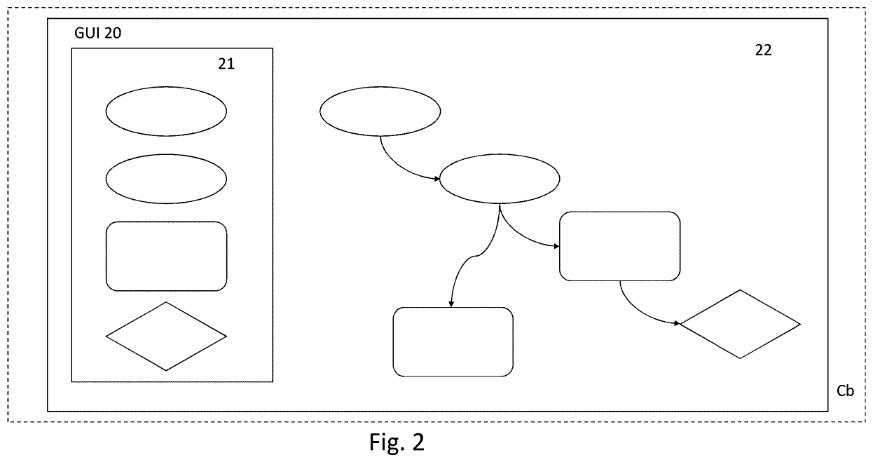

An example of such a GUI, as it may be implemented in the plant 10, is shown in FIG. 2. The GUI 20 shown in FIG. 2 graphically provides a plurality of different commands in a command window 21. These commands provided in the command window 21 can be selected by a user, for example with the aid of a computer mouse, and made available for use after corresponding insertion in/moving to a main window 22, for example by dragging with the computer mouse. In the main window 22, a link of the selected commands with one another is carried out by the user, as indicated by the arrows in FIG. 2.

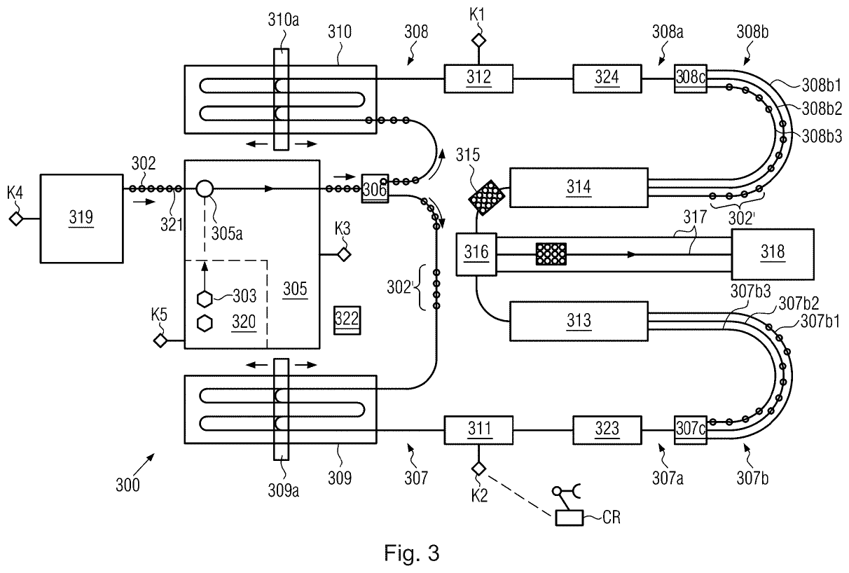

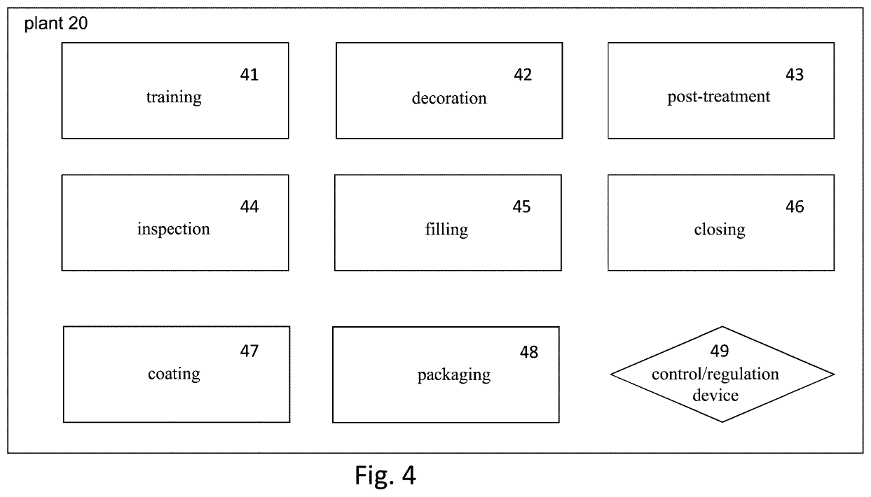

The GUI 20 thus provides low-code or no-code programming that is easy and intuitive to operate, which enables the operating sequences of the plant, for example of the plant shown in FIG. 1, FIG. 3 or FIG. 4, to be configured without specific programming knowledge.

In particular, the GUI 20 can comprise a chatbot Cb, which further simplifies the use of the GUI 20 by a user. The chatbot Cb can be a self-learning chatbot and the learning process can be carried out with the aid of a training unit that collects and evaluates data and stores received speech data and recognized semantic content in a memory. Furthermore, an operator profile of an operator can be stored and updated in the memory. For example, the chatbot Cb can learn how the level of knowledge of an operator recognized with the aid of speaker recognition changes in the course of time, and a dialog with this operator can be adapted in the course of time to the changing level of knowledge of the operator.

Furthermore, a virtual reality—or augmented reality—output can be presented to the operator via the GUI 20, which can be used both for supporting the dialog with the operator and for displaying diagnostic and other operating data. The virtual reality—or augmented reality—output can contain an in particular simulated animated representation of information, for example about operating sequences of machines in the filling plant.

An exemplary filling plant 300, which can comprise the plant 10 shown in FIG. 1, is shown in FIG. 3. The filling plant 300 for filling containers 302, 303, for example plastic bottles, with a liquid product, such as a beverage or the like, comprises a filling machine 305 for filling and closing the containers 302, 303 and a distribution device 306 provided downstream of the filling machine 305 for distributing the containers 302, 303 to two separately controllable transport paths 307, 308, in each of which at least one container buffer 309, 310 with adjustable container guides 309a, 310a is provided. Downstream of the container buffers 309, 310 are labeling machines 311, 312 and packaging machines 313, 314 for producing container packs 315. These are fed to a collection and distribution device 316 so that the container packs 315 are distributed to sorting tracks 317 provided downstream of the collection and distribution device 316 and can be fed to a picking device 318.

The transport paths 307, 308 each comprise first inlet-side sections 307a, 308a which are single-track and designed for the pressure-free transport of the containers 302, 303. Furthermore, the transport paths 307, 308 comprise second sections 307b, 308b on the output side, which are each designed with multiple lanes for the pressure-free transport of the containers 302, 303. Switches 307c, 308c or corresponding distribution devices are provided for the distribution of the containers 302, 303 from the single-track first section 307a, 308a to the individual tracks of the second section 307b, 308b, which are designed, for example, in the form of separate lanes 307b1 to 307b3, 308b1 to 308b3.

Furthermore, the filling plant 300 comprises two apparatuses for producing containers 319, 320 in the form of blow molding machines 319, 320. In the example shown, separate blow molding machines 319, 320 are provided for producing different containers 302, 303, for example, containers of different geometric shapes. At least one of the blow molding machines 319, 320 may be connected to the filling machine 3055 via an input-side transport path 321. Different incoming container streams can be fed for further processing via an input-side switch 305a. Additional production units 323, 324 may be provided in the form of shrink tunnels.

For controlling the filling plant 300 according to the disclosure, a central control/regulation device 322 (open or closed loop control) is provided, which communicates, in particular, with the distribution device 306, the container buffers 309, 310, the labeling machines 311, 312 and production units upstream from the distribution device 306, such as the filling machine 305 and the blow molding machines 319, 320. The central control/regulation device 322 can correspond to or comprise the control/regulation device 16 shown in FIG. 1. In particular, a programming of the central control/regulation device 322 can be carried out with the aid of low-code or no-code programming provided by a GUI, for example the GUI 20 shown in FIG. 2.

In the example shown, the labeling machines 311, 312 are connected to their own communication and control devices K1, K2, the filling machine 305 to its own communication and control device K3, and the blow molding machines 319, 320 to their own communication and control devices K4, K5. Each of the communication and control devices K1, K2, K3, K4 allows a user to operate the corresponding machine via a suitable interface. The communication and control devices K1, K2, K3, K4, K5 are logically assigned to the respective machines of the filling plant 300. Of course, all machines of the filling plant 300 can be equipped with their own communication and control devices, and the communication and control devices can be networked with each other so that they can exchange information about the operating states of the machines and the requirements of the operators. In general, for security reasons, the networking of the communication and control device with the other machines, mobile collaborative robots (CR), but also smartphones of the operators, etc. can be limited to a defined internal region (for example, in the form of a company's network), and at the same time an exchange on the Internet for independent learning by the communication and control device can be made possible, for example with regard to speech recognition or speaker identification.

The central control/regulation device 322 is connected to the communication and control devices K1, K2, K3, K4, K5 and can at least partially take over the coordination of the machines and transport technology, for example, for organizing the plant production and the changeover of the types of products. Logically and/or physically, each machine can be assigned a communication and control devices K1, K2, K3, K4, K5. An operator can operate the respective machines via the communication and control devices K1, K2, K3, K4, K5, for example, with the aid of voice input and voice dialogs. At least some of the communication and control devices K1, K2, K3, K4, K5 can each comprise a chatbot. The communication and control devices K1, K2, K3, K4, K5 can use display apparatuses that are positioned near the machines for displaying information. Implementations with central and distributed data processing and databases that the central control/regulation device 322 and the communication and control devices K1, K2, K3, K4, K5 can access are possible.

FIG. 4 shows an exemplary filling plant 40, which can comprise the plant 10 shown in FIG. 1, which is configured for producing and treating containers made of at least one natural organic material or at least comprising one natural organic material. The plant 40 comprises a production machine 41 for forming containers, which consist of at least one natural organic material or which comprise at least one natural organic material. For example, the container production machine 1 can be configured for forming paper containers, such as paper bottles, for example with a predetermined grass fiber content. The containers produced in the production machine 41 can be provided with an inner coating and/or outer coating in the same working machine or subsequently. The inner coating and/or outer coating can be used to ensure the mechanical stability along with the tightness of the container. The plant 40 can comprise a plurality of production machines 41 working in parallel, and the containers produced by this plurality of production machines 41 working in parallel can be brought together for further processing. Thus, a relatively high throughput can be achieved even with a relatively low production rate.

The plant 40 further comprises a decorating machine 42, to which the containers formed in the production machine 41 are fed for decoration. Decoration is carried out by labeling and/or printing the containers. The decoration machine 42 can be configured to label the containers with the aid of cold glue or hot glue by roller or spray application (GlueJet), or APS labeling. The decoration machine 42 can be configured to print the containers, for example while standing, with an ink.

In the embodiment shown in FIG. 4, the decorated containers are subjected to a post-treatment in a post-treatment machine 43, which is used to dry or cure the printing media and/or labels.

An inspection of the labeling and/or printing of the containers can be carried out in an inspection machine 44 of the plant 40. Containers that do not meet minimum quality standards in terms of their printing or labeling can be rejected and recycled, for example.

Furthermore, the plant 40 shown in FIG. 4 comprises a filling machine 45 for filling the containers produced in the production machine 41. The filling can be carried out after or before decorating the containers in the decorating machine 43.

The containers filled by the filling machine 45 are closed in a closing machine 46 of the plant 40. The closing machine 46 can be configured to close the filled containers, for example with a screw cap made of metal or plastic or by heat sealing the opening with aluminum foil, plastic or paper fiber.

Before (upstream) or after (downstream) filling in the filling machine 45, the containers can be fed to a coating machine 47, in which they are sealed by applying a coating, for example for protecting the applied ink.

Finally, the closed filled containers can be packaged in a packaging machine 48 of the plant 40.

The operation of the individual working machines 41 to 48 of the plant 40 along with devices for transporting the containers between these working machines is controlled/regulated by a central control/regulation device 49 of the plant 40. The control/regulation device 49 can comprise artificial intelligence, which can be in the form of an artificial neural network.

In particular, the central control/regulation device 49 of the plant 40 can correspond to the central control/regulation device 16 of the plant 10 shown in FIG. 1. A programming of the central control/regulation device 49 can be carried out with the aid of low-code or no-code programming provided by a GUI, for example the GUI 20 shown in FIG. 2, as described above.

1. A filling plant comprising a plurality of machines, each of which is configured to perform operating functions on the basis of a respective set of instructions;
a central control device, which is configured to control the operating functions of the plurality of machines; and
a graphical user interface, which is configured to communicate with the central control device and to provide a user with graphically supported programming of the central control device.

2. The filling plant according to claim 1, wherein each of the machines comprises an individual machine controller, which is configured to control the operating functions of the respective machine on the basis of the respective set of commands; and
wherein the central control device is configured to control each of the individual machine controllers.

3. The filling plant according to claim 1, wherein the central control device is configured to control each of the individual machine controllers on the basis of the respective set of commands; and
the graphical user interface is configured to provide the user with programmable access to the respective set of commands of the plurality of machines.

4. The filling plant according to claim 1, wherein the set of commands of each machine is stored in the respective machine or in a storage medium located external to the respective machine, for example the cloud.

5. The filling plant according to claim 1, wherein the graphical user interface is configured to provide the user with low-code or no-code programming of the central control device.

6. The filling plant according to claim 5, wherein the graphical user interface is configured to graphically provide a selection of individual commands and/or a creation of links between selected individual commands of the respective sets of commands of the plurality of machines and/or the central control device.

7. The filling plant according to claim 1, wherein the graphical user interface is configured to display information about the operating functions of the respective machine.

8. The filling plant according to claim 1, which further comprises a chatbot comprising the graphical user interface.

9. The filling plant according to claim 1, wherein the plurality of machines comprises
a production machine for forming containers from plastic or for forming containers from glass or aluminum;
a filling machine for filling the formed containers; and
a labeling machine for labeling the formed containers or filled containers.

10. The filling plant according to claim 9, wherein the production machine is a blow molding machine.

11. The filling plant according to claim 1, wherein the plurality of machines comprises
a production machine for forming containers from at least one natural organic material or comprising at least one natural organic material;
a filling machine for filling the formed containers; and
a decorating machine for decorating the formed or filled containers.
